(19) United States
(12) Patent Application Publication
(10) Pub. No.: US 2008/0222636 A1
(43) Pub. Date: Sep. 11, 2008

(54) SYSTEM AND METHOD OF REAL-TIME MULTIPLE-USER MANIPULATION OF MULTIMEDIA THREADS

(76) Inventors: David Tzat Kin Wang, Solana Beach, CA (US); Hoang-Doan Hong Vo, Anaheim, CA (US)

Correspondence Address: MERLE W. RICHMAN, III, P.O. BOX 3333, LA JOLLA, CA, 92038, US

(21) Appl. No.: 12/043,127

(22) Filed: Mar. 5, 2008

Related U.S. Application Data
(60) Provisional application No. 60/905,238, filed on Mar. 5, 2007.

(51) Int. Cl. G06F 9/46

(52) U.S. Cl. 718/100

(57) ABSTRACT

Embodiments of configuring elements of a media processing system in mechanisms are described generally herein. Other embodiments may be described and claimed.

### CROSS-REFERENCE TO RELATED APPLICATIONS

This application is related to U.S. Provisional Application 60/905,238, Attorney Docket NS001US, filed Mar. 5, 2007, and entitled “System and Method of Real-Time Multiple-User Manipulation of Multimedia Threads”, which is incorporated by reference herein.

### TECHNICAL FIELD

Various embodiments described herein relate generally to multimedia server systems (MSS), including apparatus, systems, and methods used in multimedia servers.

### BACKGROUND INFORMATION

A MSS may act as an interface between one or more users desiring to communicate a multimedia segment. A first user may provide a multimedia segment to a MSS via an interface. The MSS may generate an electronic representation of the multimedia segment where another or the same user may be able to perceive a portion of the multimedia segment via an electronic interface.

### BRIEF DESCRIPTION OF THE DRAWINGS

FIG. 1 is a block diagram of media processing architecture according to various embodiments.

FIG. 2 is a diagram of communication between a first user device, media processing system, and a second user device in a media processing architecture according to various embodiments.

FIG. 3A is a block diagram of media processing architecture according to various embodiments.

FIG. 3B is a block diagram of media processing architecture according to various embodiments.

FIG. 3C is a block diagram of media processing architecture according to various embodiments.

FIG. 4 is a block diagram of a media processing system according to various embodiments.

FIG. 5A is a flow diagram illustrating several methods according to various embodiments.

FIG. 5B is a flow diagram illustrating several methods according to various embodiments.

FIG. 6 is a block diagram of an article according to various embodiments.

FIG. 7 is a block diagram of an article according to various embodiments.

### DETAILED DESCRIPTION

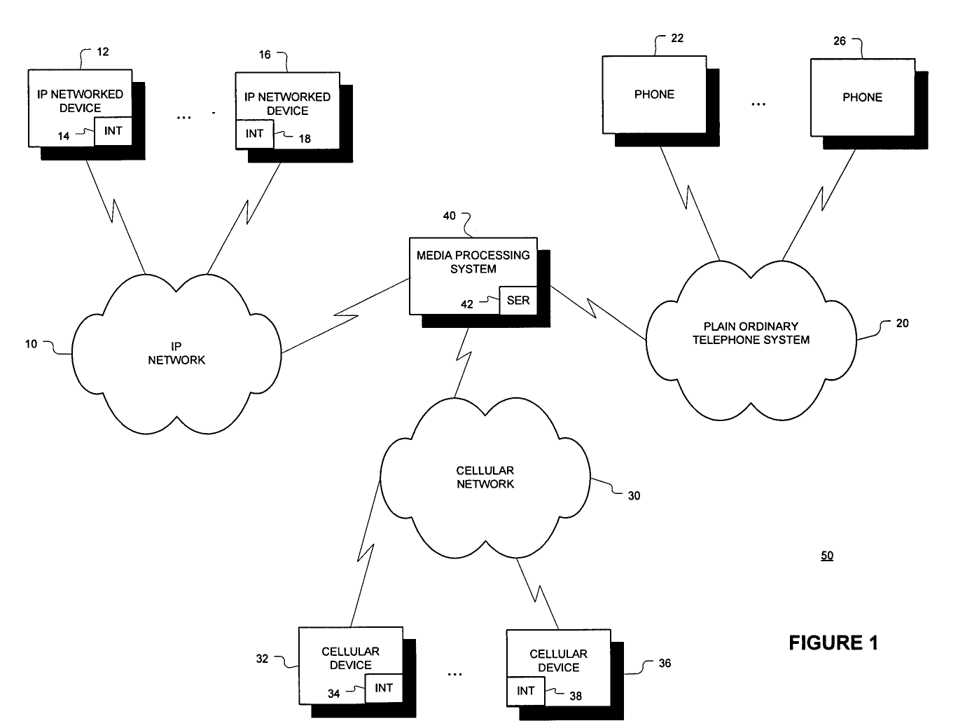

FIG. 1 is a block diagram of media processing architecture 10 comprising a media processing system (MPS) 40 and several user devices including a plurality of IP networked devices 12, 16, a plurality of phones 22, 26, and a plurality of cellular devices 32, 26, according to various embodiments. In an embodiment the media processing system (MPS) 40 may be a multimedia processing system that may process multiple media (multimedia) types but will be referred to as a media processing system (MPS) 40 hereafter. The multimedia types may include voice, video, and image media. The MPS 40 may include a server 42 that may enable communication between the MPS 40 and the plurality of IP networked devices 12, 16, the plurality of phones 22, 26, and the plurality of cellular devices 32, 26.

In an embodiment the IP networked devices 12, 16 may be coupled to the MPS 40 via an IP network 10. The IP network 10 may be a local network, a network of networks, or a worldwide network of networks, termed the “Internet”. Each IP networked device 12, 16 may include an interface 14, 18 that enables communication between the IP networked device 12, 16 and the MPS 40 server 42 via the IP network 10. The cellular devices 32, 36 may be coupled to the MPS 40 via a cellular network 30. The cellular network 30 may be a terrestrially based network or satellite based network, or combination thereof. Each cellular device 32, 36 may include an interface 34, 38 that enables communication between the cellular device 32, 36 and the MPS 40 server 42 via the cellular network 30.

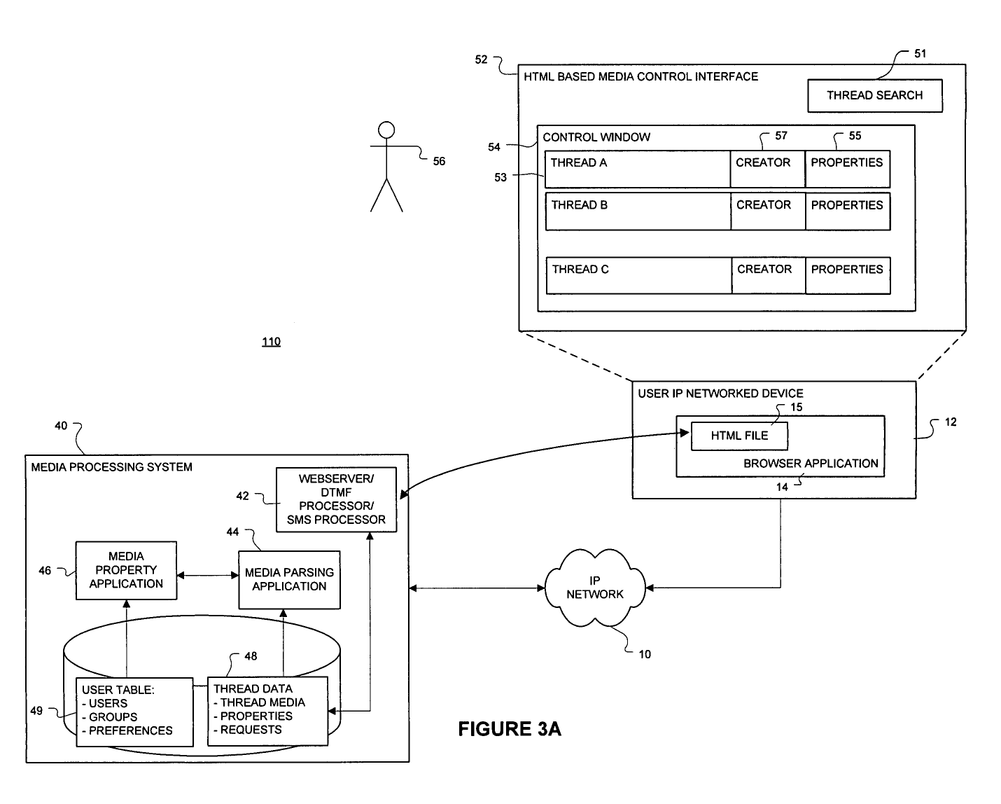

The analog phones 22, 26 may be coupled to the MPS 40 via a plain ordinary telephone system (POTS) 20. The POTS 20 may be digitally switched, analog switched, or a combination thereof Each phone 22, 26 may include a speaker, a microphone, and a dial pad (23, 25, 21 in FIG. 3B) that enables communication between the phone 22, 26 and the MPS 40 server 42 via the POTS 20. In an embodiment the MPS 40 server 42 may include a voice over Internet protocol (VOIP) server. In addition, the POTS 20 may include a VOIP server to enable communication between a phone 22, 26 and the MPS 40 server 42. The MPS 40 may establish VoIP communication between itself and a device 12, 16, 32, 36 or phone 22, 26.

In an embodiment the interfaces 14, 18, 34, and 38 may each include a hyper-text markup language (HTML) converter such as a browser and the server 42 may communicate media and media manipulation controls to a device 12, 16, 32, 36 via one or more web pages. Further, the interfaces 14, 18, 34, and 38 may convert digital signals to Dual-tone multi-frequency (DTMF) signals where combinations of the DTMF signals may control the manipulation of media signals that may be generated or forwarded from a device 12, 16, 32, 36 or phone 22, 26. Also the interfaces 14, 18, 34, and 38 may enable messaging services between a device 12, 16, 32, 36 and a server 42. The messaging services may include short messaging service (SMS) based messages that may control the manipulation of media signals.

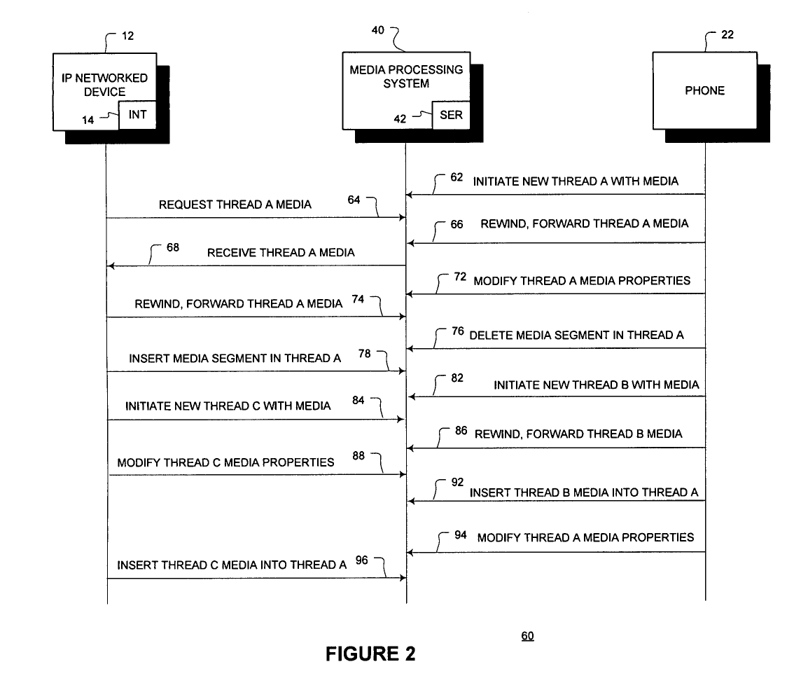

FIG. 2 is a diagram of communications 60 between a MPS 40, an IP networked device 12, and an analog phone 22 according to various embodiments. In an embodiment, a user via an analog phone 22 may desire to create an audio based media. The analog phone 22 user may generate an initiate media signal via one or more predetermined DTMF signals. In an embodiment each media signal is termed a thread. Accordingly, an analog phone 22 user may initiate or request initiation of a new thread with audio media 62. In an embodiment the MPS 40 server 42 may automatically create a new thread when an analog phone user 22 communicates with the MPS 40.

An IP networked device 12 user may view a list of available media threads or open threads via a webpage provided by the MPS 40 server 42 or receive a list of available media threads via SMS message(s). The IP networked device 12 user may also use DTMF signals or SMS message(s) to request or review one or more media threads such as requesting thread A media 64 from the MPS 40. In the interim a phone 22 user may generate a manipulate media request 66 to rewind or forward the playback or recording location in the thread A media. One or more DTMF signals may represent a request to forward or rewind the current position of media in a thread a predetermined distance (the distance representing time segment or frames in an embodiment). In an embodiment each media manipulation request 62 to 96 may be stored in a queue or table (48 shown in FIGS. 3A and 3B). The queue may be a first in first out (FIFO) queue where requests are processed in the order received and request conflicts rejected based on the order received.

The IP networked device 12 user may receive thread A media 68 from the MPS 40 server 42. The media may be a predetermined segment of the thread A at the beginning of the thread. The segment may also be started at the location set by the communication 66 in an embodiment. A user via phone 22 may generate a request to modify at least a segment of a thread's media properties 72. A user via one or more DTMF signals may request to modify one or more media properties of a thread where the properties may include volume, frequency equalization, pitch, compression of segment, decompression of segment, and other properties for audio media and various properties of other media.

A IP networked device 12 user may be able to rewind or forward the playback location of thread A media 74 via a webpage provided by the MPS 40 server 42 where the webpage may provide an indication of the entire thread A and permit a device 12 user to select any location in the thread. The IP networked device 12 user may also use DTMF signal(s) or SMS message(s) to request movement of the thread A media playback location forward or backwards (rewind) a predetermined distance or percentage. A user via one or more DTMF signals or SMS message(s) may request to delete a segment or section of a thread including a predetermined segment, percentage, or the entire thread A 76.

A IP networked device 12 user may be able to insert a media segment into thread A 74 via a webpage provided by the MPS 40 server 42 where the webpage may provide an indication of the entire thread A or via SMS message(s) and permit a device 12 user to select any location in the thread to insert a media segment or to be replaced by a media segment. It is noted that the insertion location may not be present after processing the delete media segment request 76. In an embodiment the device 12 user may be able to insert other media types into the thread A. For example a user may insert a video segment into the thread A. The MPS 40 may convert the entire thread in video media where the audio segment has a predetermined or fixed image(s) for video.

A phone 22 user may be able to manipulate or review the audio content of the media. In an embodiment the MPS 40 may convert video content to a form that may be perceived audibly for a phone 22 user, e.g., the audio signal may describe characteristics of the video image content. It is noted that the user may be able to select the media segment to be inserted, run parallel, or replace a segment of an existing segment of a thread. Accordingly during playback a user may elect to receive segment(s) generated from specific users or devices or block segment(s) generated by specific users or devices 12, 16, 22, 26, 32, 36.

A phone user 22 may initiate a new thread B with media 82 as described above with relationship to 62. Similarly, a IP networked device 12 user may initiate a new thread C with media via a webpage, SMS message(s), or DTMF signal(s) 84. A phone 22 user may change the media playback position via one or more DTMF signals 86 of the Thread B. An IP networked device 12 user may modify one or more properties of the thread C media via a webpage, SMS message(s), or DTMF signals 88. The webpage may enable the user to change or modify several media properties in tandem. A phone 22 user or IP networked device 12 user may insert media from a first thread into a location of a second thread (from thread B into thread A in request 92 and from thread C into thread A in request 96). As noted the phone user 22 may elect the segment to replace, insert, or combine with one or more existing segment(s). A user may insert a media segment into a plurality of threads or media segment tracks in an embodiment. When combined each segment may have a separate effective segment track so a user or device may request which user segments (tracks) they wish to receive for a particular thread. Phone 22 user may also change the thread A media properties after thread B insertion via request 94.

FIG. 3A is a block diagram of media processing architecture 110 comprising a media processing system (MPS) 40 coupled to an IP networked device 12, 16 via an IP network 10 according to various embodiments. The MPS 40 may include a hypertext meta language (HTML) generator or webserver, DTMF processor, and SMS processor 42, media parsing application 44, media property application, user table 49, and thread data table or queue 48. The device 12 may include a browser application 13 as part of the interface 14 to receive process, generate, and communicate HTML pages between itself and the MPS 40. The device 12 may include a SMS application 31 to receive process, generate, and communicate SMS messages between itself and the MPS 40 (such as shown in FIG. 3C). The device 12 may provide a user 56 a media control or manipulation interface 52. The interface 52 may include a thread search window 51 and thread control window 54. The thread control window 54 may list threads 53, creator information 57, and thread media properties 55 for one or more active threads where the threads may be located in a search 51, forwarded to the user 56 from another user or created by the user 56.

The MPS 40 webserver—DTMF processor—SMS processor 42 may receive thread processing or manipulation requests from the device 12. The requests may be embedded in an HTML page, SMS message(s), or include one or more DTMF signals (where the device 12 may include a dial pad 21 such as shown in FIG. 3B and be selectable via the media control interface 52.) The webserver/DTMF and SMS processor 42 may extract thread manipulation requests from received HTML content, SMS message(s) or DTMF signal(s) for storage in the thread data table 48. The media parsing application 44 may retrieve and process requests stored in the thread data table 48. The media parsing application 44 may first determine whether the request is valid and inform the requestor if invalid and remove invalid requests. Otherwise the media parsing application 44 may process the request in conjunction with the media property application 46 as a function of the request.

The media property application 46 may change one or more properties of a thread media segment stored in the thread data table or queue 48. The user table 49 may information about users, thread origination, user groups, and forwarding, and user preferences. The user preferences may include media format preferences, media property preferences, media forwarding preferences such as to one or more users, devices 12, 16, 32, 36 or phone 22, 26, and media manipulation preferences. The media parsing application 44 and media property application 46 may modify media segments of threads and store the updated threads in the thread table 48 and forward representations of a segment of a thread to the device 12. A user 56 may perceive a thread media by selecting the thread 53 via the control window 54.

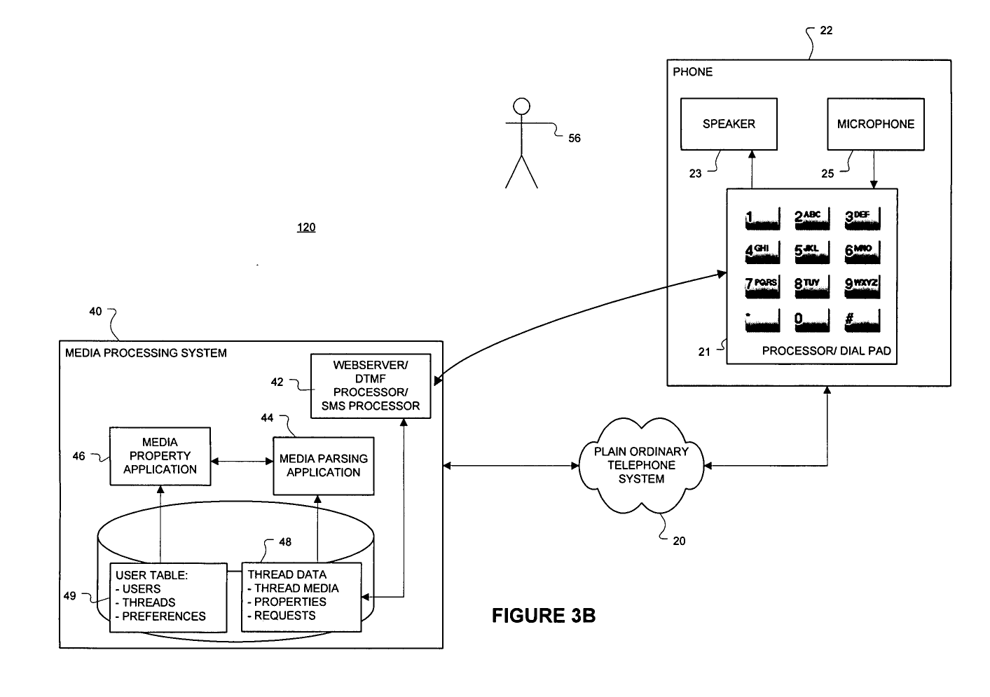

FIG. 3B is a block diagram of media processing architecture 120 comprising a media processing system (MPS) 40 coupled to a phone 22 via a POTS 20 according to various embodiments. The phone 22 may be coupled the MPS 40 via a VOIP server (117 in FIG. 4) coupled to a IP network in an embodiment. The phone 22 may include a speaker 23, microphone 25, and dial pad 21. It is noted that the IP networked device 12, 16, or cellular device 32, 34 may include a speaker 23, microphone 25, and dial pad 21 and thus function as a phone 22, 24 in an embodiment. In the architecture 120 a phone 22 user 56 may use the dial pad 21 to generate one or more DTMF signals to indicate a desired media manipulation request. In an embodiment the media may represent an audio signal and a user 56 may generate or initiate a thread via a phone 22 by calling a number associated with thread initiation or being forwarded to a user's voice processing system where the MPS 40 may manage threads created by a user's voice processing system. A user receiving an initiated audio thread via a device 12, 16, 32, 36, or phone 22, 26 may modify the audio thread as described and then forward the thread to one or more users or their related devices based on users preferences. Similarly additional users may modify the thread as discussed.

FIG. 3C is a block diagram of media processing architecture 300 comprising a media processing system (MPS) 40 coupled to a cellular device 32, 36 via a cellular network 30 according to various embodiments. The device 32 may include an SMS application 31 to receive process, generate, and communicate SMS message(s) 35 between itself and the MPS 40. The device 32 may provide a user 56 a SMS based media control or manipulation interface 37. The interface 37 may include an SMS search window 301 and control window 303. The SMS control window 303 may list SMS messages related to threads 305, creator information 307, and SMS properties 309 for one or more active threads where the threads may be located in a SMS search 301, forwarded to the user 56 from another user or created by the user 56.

The MPS 40 webserver—DTMF processor—SMS processor 42 may receive thread processing or manipulation requests from the device 32 via SMS message(s). The webserver/DTMF and SMS processor 42 may extract thread manipulation requests from received SMS message(s) for storage in the thread data table 48. The media parsing application 44 may retrieve and process requests stored in the thread data table 48.

In an embodiment, the MSP 40 may further include a number of modules such as shown in FIG. 4 including an initiate thread module 102, forward thread media module 104, review, forward thread media module 106, modify thread media properties module 108, media segment insertion module 112, SMS processing module 114, media segment deletion module 116, process HTML page module 118, generate HTML page module 119, and VOIP server module 117. In an embodiment, the initiate thread module 102 may create a thread table enter based on receipt of media from a phone 22, 26 or device 12, 16, 32, 36 or an initiate thread request from a phone 22, 26 or device 12, 16, 32, 36. The initiate thread module 102 may record or store media received from a device 12, 16, 32, 36 or phone 22, 26 upon thread initiation.

The forward thread media module 104 may enable a user to send a media segment from a thread to one or more users, phones 22, 26, or devices 12, 16, 32, 36. The module 104 may forward to a media segment to one or more users, phones 22, 26, or devices 12, 16, 32, 36 based on a users' preferences in the user table 49. The rewind, forward thread media playback or record location module may enable one or more users via phones 22, 26, or devices 12, 16, 32, 36 to change the playback or record location or position within a media segment in a thread. The modify thread media properties module may enable one or more users via phones 22, 26, or devices 12, 16, 32, 36 to change one or more properties of a media segment. The module 108 may retrieve a user's media properties preferences from the user table 49.

The media segment insertion module 112 may enable one or more users via phones 22, 26, or devices 12, 16, 32, 36 to select a media segment location from a first thread and one of insert, replace, or combine (in one or more second effective tracks) such selected media segment into the thread, a second thread, or a plurality of threads or media segments (or tracks). The media segment insertion module 112 may record or store media received from a device 12, 16, 32, 36 or phone 22, 26 for insertion in a thread. The media segment deletion module 116 may enable one or more users via phones 22, 26, or devices 12, 16, 32, 36 to select a media segment from a thread to be removed or deleted. The media segment to be deleted may be from a one or more parallel media segments tracks of a thread.

The SMS processing module 114 may extract media manipulation requests from received SMS message(s) and store the extracted request in the thread table 48. The SMS processing module 114 may also create SMS messages that include information regarding one or more threads, creator information, and thread property information for processing by a SMS application 31. The process HTML page module 118 may extract media manipulation requests from a received HTML page and store the extracted request in the thread table or queue 48. The generate HTML page module may create an HTML page including one or more threads, creator information, and thread property information such as shown in FIG. 3A and fields that enable a user to request manipulation or modification of one or more threads.

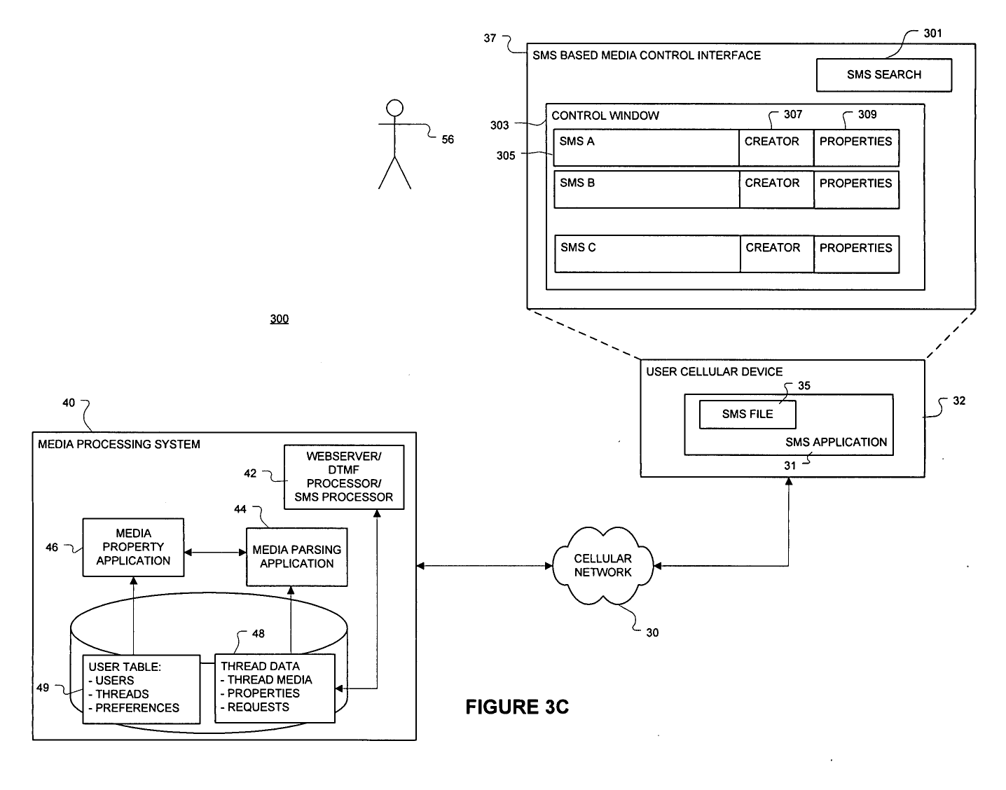

The VOIP server module 117 may enable the MPS 40 to host, receive, and process VOIP based communications between the MPS 40 and one or more users via phones 22, 26, or devices 12, 16, 32, 36 or between two or more users via phones 22, 26, or devices 12, 16, 32, 36. FIG. 5A is a flow diagram of a thread manipulation request processing method 150 according to various embodiments. The method 150 may receive a thread manipulation request from user via a phone 22, 26 or device 12, 16, 32, 36 or from a queue in table 48 (activity 152). The method may then evaluate the thread manipulation request to determine whether the request can be processed. Given multiple devices or phones may be request manipulation of a thread, a request may be received for a media segment that is not present in a thread due to the processing of a previous request (activity 154).

When a request conflict is detected (activity 156), the method inform the requester that the request can not be processed and delete request (activity 158). The method 150 may generate an HTML page or an audio message to be forwarded to a user via a device 12, 16, 32, 36 or phone 22, 26. When a request conflict is not detected (activity 156), the method may perform the thread manipulation request (activity 120) using one or more of the modules 102, 104, 106, 108, 112, 116, 117, 118, 119 shown in FIG. 4. FIG. 5B is a flow diagram of a perform thread manipulation request method 120 according to various embodiments.

The method 120 may initiate a new thread (activity 124) when the request includes a new thread request (activity 122). Thread initiation may include creating an entry in the thread table 48 and user table 49. The method 120 may change the playback or record position of a thread or media segment (including one or more parallel tracks) (forward, rewind) (activity 128) when the request includes an alter media position request (activity 126). The method 120 may change one or more media properties of a media segment (activity 134) when the request includes a media property modification request (activity 132). The method 120 may insert a media segment from a thread into one or more threads (replace, insert between, combine, or create parallel track) (activity 138) when the request includes a segment insertion request (activity 136) where the media may be recorded and stored. Also, the method 120 may delete a media segment (from one or more tracks when applicable) from a thread (activity 144) when the request includes a segment deletion request (activity 142).

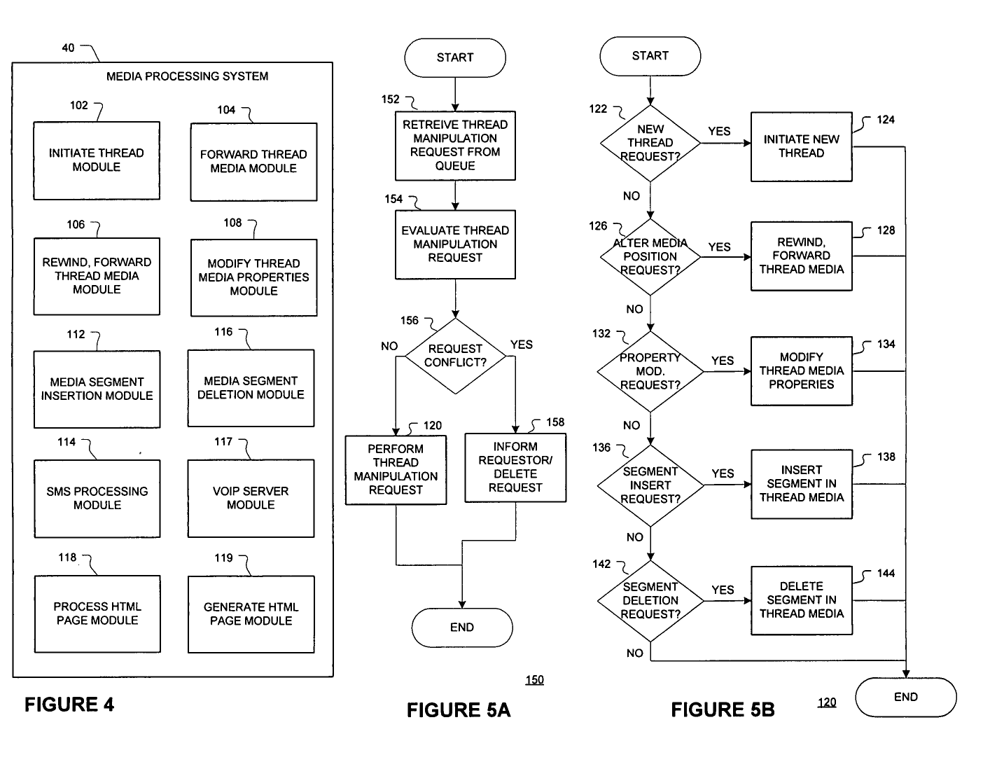

FIG. 6 illustrates a block diagram of a device 230 that may be employed as a MPS 40 in various embodiments. The device 230 may include a central processing unit (CPU) 232, a random access memory (RAM) 234, a read only memory (ROM) 236, a storage unit 238, a modem/transceiver 244, and an antenna 246. The CPU 232 may include a webserver/DTMF processor 252 and a media parser 254. The RAM 234 may include a queue or table 248 where the queue 248 may be used to store the user table and thread table. The storage 238 may also include a queue or database 256 where the queue 256 may be used to store the user table and thread table. The storage 238 may be local or coupled to the device 230 via one or more networks 10, 20, 30. The webserver/DTMF processor 252 and the media parser 254 may be separate elements.

The modem/transceiver 244 may couple, in a well-known manner, the device 230 to the IP network 10, POTS 20, and cellular network 30 to enable communication with the devices 12, 16, 32, 36 and phones 22, 26. In an embodiment, the modem/transceiver 244 may be a wireless modem or other communication device that may enable communication with the devices 12, 16, 32, 36 and phones 22, 26. The CPU 232 via the webserver/DTMF processor 252 may direct communication between modem 244 and a device 12, 16, 32, 36 or phone 22, 26.

The ROM 236 may store program instructions to be executed by the CPU 232, media parser 254, or webserver/DTMF processor 252. The RAM 234 may be used to store temporary program information, queues, databases, and overhead information. The storage device 238 may comprise any convenient form of data storage and may be used to store temporary program information, queues, databases, and overhead information.

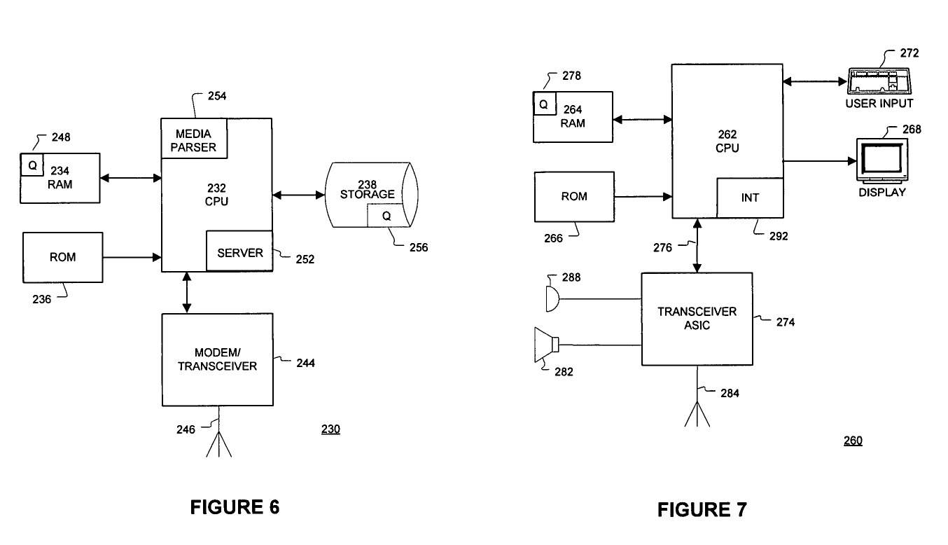

A device 260 is shown in FIG. 7 that may be used in various embodiments as a device 12, 16, 32, 36. The device 60 may include a central processing unit (CPU) 262, a random access memory (RAM) 264, a read only memory (ROM″) 266, a display 268, a user input device 272, a transceiver application specific integrated circuit (ASIC) 274, a microphone 288, a speaker 282, and an antenna 284. The CPU 262 may include an interface 292. The RAM 264 may include a queue 278 where the queue 278 may store thread media. The interface 292 may process messages or pages from and generate messages or pages for the MPS 40.

The ROM 266 is coupled to the CPU 262 and may store the program instructions to be executed by the CPU 262 and the interface 292. The RAM 264 is coupled to the CPU 262 and may store temporary program data, overhead information, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear received messages, media, or pages from the MPS 40.

The microphone 288 and speaker 282 may be incorporated into the device 260. The microphone 288 and speaker 282 may also be separated from the device 260. Received data may be transmitted to the CPU 262 via a serial bus 276 where the data may include messages, media, or pages received, messages, media, or pages to be transmitted, or protocol information. The transceiver ASIC 274 may include an instruction set necessary to communicate messages, media or pages in architecture 50, 110 (for the IP network 16 or cellular network 30). The ASIC 274 may be coupled to the antenna 284 to communicate wireless messages, media, or pages within the architecture 50, 110. When a message is received by the transceiver ASIC 274, its corresponding data may be transferred to the CPU 262 via the serial bus 276. The data can include wireless protocol, overhead information, media, and pages to be processed by the device 260 in accordance with the methods described herein.

Any of the components previously described can be implemented in a number of ways, including embodiments in software. Any of the components previously described can be implemented in a number of ways, including embodiments in software. Thus, the CPU 232, VoIP server 254, server 252, modem/transceiver 244, antenna 246, storage 238, RAM 234, ROM 236, queue 248, queue 256, CPU 262, interface 292, transceiver ASIC 274, antenna 284, microphone 288, speaker 282, ROM 266, RAM 264, queue 278, user input 272, display 268, webserver/DTMF processor 252, and media parser 254 may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A multimedia thread processing module, including:
a multimedia thread manipulation request receiver to receive a multimedia thread manipulation request from a second user to manipulate a multimedia thread initiated by a first user; and
a multimedia thread modifier to modify the multimedia thread initiated by a first user based on the second user request.

2. The multimedia thread processing module of claim 1, wherein the multimedia thread manipulation request is wireless based message.

3. The multimedia thread processing module of claim 2, wherein the multimedia thread includes a voice segment and the manipulation request modifies the voice segment.

4. The multimedia thread processing module of claim 1, further including a multimedia thread generator to generate a multimedia thread based on a multimedia thread modified as a function of the second user request.

5. The multimedia thread processing module of claim 1, further including a multimedia thread generation request receiver to receive a multimedia thread generation request from a third user.

6. The multimedia thread processing module of claim 5, further including a multimedia thread generator to generate a multimedia thread for the third user based on a multimedia thread modified as a function of the second user request and the multimedia thread generation request received from the third user.

7. The multimedia thread processing module of claim 6, wherein the third user has at least one multimedia format preference and multimedia thread generator generates a multimedia thread for the third user based on a multimedia thread modified as a function of the second user request, the multimedia thread generation request received from the third user, and the third user at least one multimedia format preference.

8. The multimedia thread processing module of claim 4, further including a multimedia thread segment converter to convert at least a segment of the multimedia thread from a first multimedia format to a second multimedia format.

9. The multimedia thread processing module of claim 4, the multimedia thread segment converter converting at least a segment of the multimedia thread from a first text format to one of a video and a voice format.

10. The multimedia thread processing module of claim 7, further including a multimedia thread segment converter to convert at least a segment of the multimedia thread from a first multimedia format to a second multimedia format based on the third user at least one multimedia format preference.

11. The multimedia thread processing module of claim 2, wherein the multimedia thread includes a voice segment and the manipulation request overlaps at least a portion of the voice segment with another multimedia segment.

12. A multimedia thread processing method, including:
receiving a multimedia thread manipulation request from a second user to manipulate a multimedia thread initiated by a first user; and
modifying the multimedia thread initiated by a first user based on the second user request.

13. The multimedia thread processing method of claim 12, wherein the multimedia thread manipulation request is wireless based message.

14. The multimedia thread processing method of claim 13, wherein the multimedia thread includes a voice segment and the method modifies the voice segment based on the manipulation request.

15. The multimedia thread processing module of claim 12, further including receiving a multimedia thread generation request from a third user.

16. The multimedia thread processing module of claim 15, further including generating a multimedia thread for the third user based on a multimedia thread modified as a function of the second user request and the multimedia thread generation request received from the third user.

17. The multimedia thread processing module of claim 16, wherein the third user has at least one multimedia format preference and generating a multimedia thread for the third user based on a multimedia thread modified as a function of the second user request, the multimedia thread generation request received from the third user, and the third user at least one multimedia format preference.

18. The multimedia thread processing module of claim 17, further including converting at least a segment of the multimedia thread from a first multimedia format to a second multimedia format based on the third user at least one multimedia format preference.

19. An article including a machine-accessible medium having associated information, wherein the information, when accessed, results in a machine performing:
receiving a multimedia thread manipulation request from a second user to manipulate a multimedia thread initiated by a first user; and
modifying the multimedia thread initiated by a first user based on the second user request.

20. The article of claim 19, wherein the multimedia thread manipulation request is wireless based message.

21. The article of claim 20, wherein the information, when accessed, results in a machine performing:
receiving a multimedia thread generation request from a third user; and
generating a multimedia thread for the third user based on a multimedia thread modified as a function of the second user request and the multimedia thread generation request received from the third user.

22. The article of claim 20, wherein the information, when accessed, results in a machine performing:
converting at least a segment of the multimedia thread from a first multimedia format to a second multimedia format based on the third user at least one multimedia format preference.
